(19) United States
(12) Patent Application Publication
(10) Pub. No.: US 2014/0147072 A1
(43) Pub. Date: May 29, 2014

(54) ELECTRO-OPTIC MODULATOR

(71) Applicant: HON HAI PRECISION INDUSTRY CO., LTD., New Taipei (TW)

(72) Inventor: HSIN-SHUN HUANG, New Taipei (TW)

(73) Assignee: HON HAI PRECISION INDUSTRY CO., LTD., New Taipei (TW)

(21) Appl. No.: 13/736,955

(22) Filed: Jan. 9, 2013

(30) Foreign Application Priority Data
Nov. 29, 2012 (TW) 101144858

(51) Int. Cl. G02F 1/365

(52) U.S. Cl. CPC G02F 1/365
USPC 385/2

(57) ABSTRACT

An electro-optic modulator includes a substrate, a Y-shaped waveguide, a ground electrode, a first modulating electrode, and a second modulating electrode. The substrate includes a top surface. The Y-shaped waveguide is implanted into the top surface, and includes a first branch and a second branch. The first branch is dedicated to the application of a transverse electric wave and the second branch is dedicated to the application of a transverse magnetic wave. The ground electrode, the first modulating electrode, and the third modulating electrode are all strip-shaped and positioned on the top surface. The first modulating electrode and the ground electrode are located at two sides of the first second branch, and the ground electrode covers the second branch. The second modulating electrode is located at a side of the second branch opposite to the first branch.

### BACKGROUND

1. Technical Field

The present disclosure relates to integrated optics, and particularly to an electro-optic modulator.

2. Description of Related Art

Electro-optic modulators, such as Mach-Zehner electro-optic modulators, change a refractive index of a branch of a Y-shaped waveguide (hereinafter the second branch) using a modulating electric field, utilizing electro-optic effect. Thus, the modulator can alter a phase of lightwaves traversing the second branch. As a result, the lightwaves traversing the second branch have a phase shift and thus interfere with lightwaves traversing another branch of the Y-shaped waveguide (hereinafter the first branch). An output of the Y-shaped waveguide is modulated as the output depends on the phase shift, which in turn depends on the modulating electric field. However, a bandwidth of the electro-optic modulators is often less than satisfactory.

Therefore, it is desirable to provide an electro-optic modulator, which can overcome the above-mentioned problems.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is an isometric schematic view of an electro-optic modulator, according to an embodiment.

FIG. 2 is a cross-sectional view taken along a line II-II of FIG. 1.

### DETAILED DESCRIPTION

Embodiments of the present disclosure will be described with reference to the drawings.

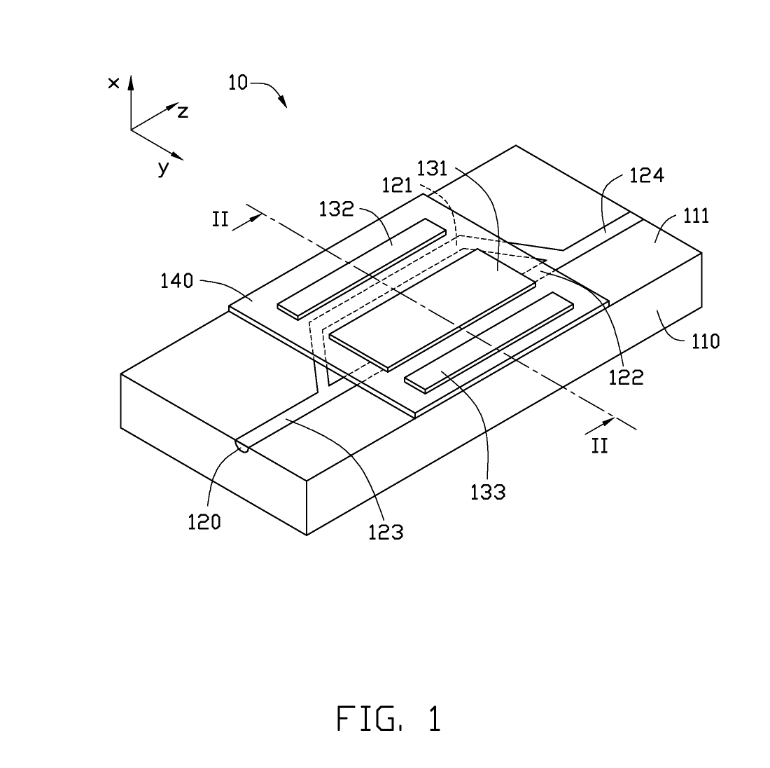

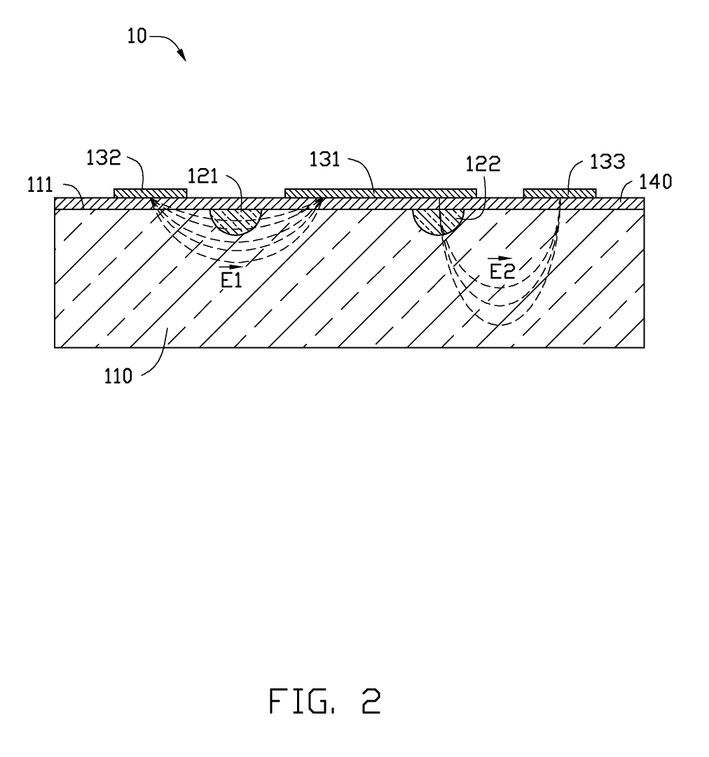

Referring to FIGS. 1-2, an electro-optic modulator 10, according to an embodiment, includes a substrate 110, a Y-shaped waveguide 120, a ground electrode 131, a first modulating electrode 132, and a second modulating electrode 133. The substrate 110 includes a top surface 111. The Y-shaped waveguide 120 is embedded into the top surface 111, and includes a first branch 121 and a second branch 122. The first branch 121 is dedicated for transmitting transverse electric wave (TE mode) and the second branch 122 is dedicated for transmitting transverse magnetic wave (TM mode). That is, the first branch 121 only transmits the TE mode and the second branch 122 only transmits the TM mode. The ground electrode 131, the first modulating electrode 132, and the third modulating electrode 133 are all strip-shaped, positioned on the top surface 111, and arranged parallel with the first branch 121, and the second branch 122. The first modulating electrode 132 and the ground electrode 131 are located at each side of the first second branch 121, and the ground electrode 131 covers the second branch 122. The second modulating electrode 133 is located at a side of the second branch 122 opposite to the first branch 121.

As such, the first branch 121 and the second branch 122 can independently be modulated with different signals (for example, signals in form of different modulating voltages can be applied to the first modulating electrode 132 and to the second modulating electrode 133 simultaneously), a bandwidth of the electro-optic modulator is increased. In addition, crosstalk between the first branch 121 and the second branch 122 is avoided as the TE and TM modes do not interfere with each other. Finally, the first modulating electrode 132 and the second modulating electrode 133 share the same ground electrode 131, providing simplicity to the electrode arrangements.

The substrate 110 is made of lithium niobate (LiNbO₃) crystal to increase a bandwidth of the electro-optic modulator 10 as the LiNbO₃ crystal has a high response speed.

In addition to the first branch 121 and the second branch 122, the Y-shaped waveguide 120 includes an input section 123 and an output section 124. The first branch 121 and the second branch 122 branch from the input section 123 and converge into the output section 124. The input section 123 and the output section 124 are formed by diffusing titanium into the substrate 110 (Ti:LiNbO₃) and can transmit both the TE mode and the TM mode. The first branch 121 is formed by diffusing titanium into the substrate 110 and then further diffusing zinc-nickel alloy into the substrate 110, and can only transmit the TE mode. The second branch 122 is formed by diffusing titanium into the substrate and then further diffusing Gallium into the substrate 110, and can only transmit the TM mode.

The ground electrode 131, the first modulating electrode 132, and the second modulating electrode 133 are all rectangular strips and are all as long as the first branch 121 and are aligned with the first branch 121.

In a coordinate system XYZ (see FIG. 1), wherein X axis is a height direction of the substrate 110 (i.e., perpendicular to the top surface 111), Y axis is a width direction of substrate 110 (parallel with the top surface 111 and perpendicular to the first branch 121), and Z axis is a length direction of the substrate 110 (i.e., along the first branch 121), the TE mode only has an electric field component \vec{Ey} vibrating along the Y axis. The TM mode only has an electric field component \vec{Ex} vibrating along the X axis and an electric field component \vec{Ez} vibrating along the Z axis. As such, a portion of a first modulating electric field \vec{E}1 , which is generated by the first modulating electrode 132 and the ground electrode 131, interacts with the first branch 121 and is substantially parallel with the Y axis, and thus can effectively modulate the TE mode. A portion of a first modulating electric field \vec{E}2, which is generated by the second modulating electrode 133 and the ground electrode 131, interacts with the second branch 122 and is substantially parallel with the X axis, and thus can effectively modulate the TM mode.

To avoid lightwaves being absorbed by the ground electrode 131, the first modulating electrode 132, and the second modulating electrode 133, the electro-optic modulator 10 further includes a buffer layer 140 sandwiched between the substrate 110 and all of the ground electrode 131, the first modulating electrode 132 and the second modulating electrode 133. The buffer layer 140 can be made of silicon dioxide.

It will be understood that the above particular embodiments are shown and described by way of illustration only. The principles and the features of the present disclosure may be employed in various and numerous embodiment thereof without departing from the scope of the disclosure as claimed. The above-described embodiments illustrate the possible scope of the disclosure but do not restrict the scope of the disclosure.

What is claimed is:

1. An electro-optic modulator, comprising:
a substrate comprising a top surface;
a Y-shaped waveguide implanted into the top surface and comprising a first branch and a second branch, the first branch being dedicated for transmitting transverse electric wave, the second branch being dedicated for transmitting transverse magnetic wave;
a ground electrode;
a first modulating electrode; and
a second modulating electrode;
wherein the ground electrode, the first modulating electrode, and the third modulating electrode are all strip-shaped and positioned on the top surface, the first modulating electrode and the ground electrode are located at two sides of the first second branch and opposite to each other, and the ground electrode covers the second branch, and the second modulating electrode is located at a side of the second branch opposite to the first branch.

2. The electro-optic modulator of claim 1, wherein the substrate is made of lithium niobate crystal.

3. The electro-optic modulator of claim 1, wherein the Y-shaped waveguide comprises an input section and an output section, and the first branch and the second branch are branched from the input section and converge into the output section.

4. The electro-optic modulator of claim 3, wherein the input section and the output section are formed by diffusing titanium into the substrate and configured for transmitting both the transverse electric wave and the transverse magnetic wave.

5. The electro-optic modulator of claim 3, wherein the first branch is formed by diffusing titanium into the substrate and then further diffusing zinc-nickel alloy into the substrate.

6. The electro-optic modulator of claim 3, wherein the second branch is formed by diffusing titanium into the substrate and then further diffusing Gallium into the substrate.

7. The electro-optic modulator of claim 1, wherein the ground electrode, the first modulating electrode, and the second modulating electrode are all rectangular strips and are all as long as and aligned with the first branch.

8. The electro-optic modulator of claim 1, further comprising a buffer layer sandwiched between the substrate and all of the ground electrode, the first modulating electrode and the second modulating electrode.

9. The electro-optic modulator of claim 8, wherein the buffer layer is made of silicon dioxide.
